(19) United States
(12) Patent Application Publication
(10) Pub. No.: US 2012/0284099 A1
(43) Pub. Date: Nov. 8, 2012

(54) SYSTEM AND METHOD FOR MANAGING HAIR STYLIST REFERRALS

(76) Inventor: John Patrick Dixon, Los Gatos, CA (US)

(21) Appl. No.: 13/464,978

(22) Filed: May 5, 2012

Related U.S. Application Data
(60) Provisional application No. 61/483,651, filed on May 7, 2011.

(51) Int. Cl. G06Q 30/02

(52) U.S. Cl. 705/14.16

(57) ABSTRACT

A web based system method of managing hair stylist referrals, based on a web server that provides a searchable directory of hair stylists. The system provides a simple method to generate gift certificates that are customized to each individual stylist, and a simple method to allow the hair stylists' customers to refer their friends by electronically transmitting these customized gift certificates to their friends.

### CROSS REFERENCE TO RELATED APPLICATIONS

This invention claims the priority benefit of U.S. provisional application 61/483,651 entitled “SYSTEM AND METHOD FOR MANAGING HAIR STYLIST REFERRALS”, inventor John Patrick Dixon, filed May 7, 2011; the contents of this disclosure are incorporated herein by reference.

### BACKGROUND OF THE INVENTION

1. Field of the Invention

This invention is in the field of Internet based portfolio management, customer management, and e-commerce functions for hair stylists and hair salons.

2. Description of the Related Art

Advances in computer and network technology have greatly transformed the modern world. In particular, Internet (e.g. web browser/web server) technology has, for a substantial segment of the population, made a big impact on career management and electronic commerce. Today, for example, many skilled workers, such as engineers and office workers can present their resumes for potential employers on popular websites such as Linkedin.com and Monster.com. Even independent contractors, such as artists and programmers, can advertise their services on sites such as Elance.com, Guru.com, and other popular sites.

Internet technology has had a huge impact on commerce as well. Some popular websites such as Amazon.com allow a great many different products to be sold. Other websites, such as Groupon.com enable coupons to be provided to various purchasing groups.

Despite these technical advances, however, not all segments of the population are presently well served by Internet technology. Thus further advances would be desirable.

### BRIEF SUMMARY OF THE INVENTION

The invention is based, in part, on the insight that although various Internet based (e.g. web server/web browser based) methods and systems for managing resumes, portfolios, customer relations, and ecommerce have become popular in recent years, certain segments of the workforce have been left behind.

The invention is further based, in part, on the insight that in particular, various personal services vendors, here exemplified by hair stylists (sometimes also called beauticians) and hair salons have not been well served by prior-art web-based portfolio management, resume management, or ecommerce systems.

Hair stylists (here generally referred to as simply stylists) and hair salons (here generally referred to as simply salons) have some unique needs that have not fit in well with prior art internet technology. Stylists as a rule have limited time and often limited inclination to write complex resumes or manage complex ecommerce systems. A second problem is that hair stylist work is a uniquely personal service, where a proper match in both artistic sense and interpersonal relations between the stylist and the client is essential for a long term business relationship. Thus, to an extent far greater than the average profession, hair stylists rely on word of mouth and client referrals to obtain new business. This is due, in part, to the fact that a client with a particular artistic sense and interpersonal style may often have friends with a similar type artistic sense and interpersonal style. Thus, all else being equal, when a satisfied customer refers a friend to a stylist, the chances that the friend will also value that stylist's artistic sense and interpersonal style will be fairly good, and this in turn can lead to more repeat business.

One of the ways that stylists can encourage referrals is through the use of gift certificates or coupons, entitling certain customers, often new customers, to a discount on the stylists' services.

Thus in one embodiment, the invention may be an Internet based system and method to comprehensively manage stylist and salon contact information and portfolios. The invention may further help stylist manage and encourage customer referrals to friends by way of providing a convenient way for satisfied clients to distribute stylist gift certificates to their friends. This helps stylists get new business, and also helps create a social network of stylist clients that is potentially quite valuable for manufacturers, distributors, and advertisers in this field as well.

In some embodiments, the invention may further utilizes smart phone technology, and for example, can make use of QR codes (or other visual identification marks, or even RFID chips) and image or video capable smart phones (as well as QR code reading application software (apps) residing on the smart phones) to further streamline the process of both looking up individual stylists or salons, and also dispensing gift certificates/coupons.

In an alternative embodiment, the invention may also incorporate co-branding functionality. Thus, for example, the invention may provide a convenient web-based interface through which an advertiser, distributor, or manufacturer of beauty products, may work with the stylist to create co-branded coupons that not only promote the stylist, but which also promote various related product or services as well. For example, a stylist gift certificate to a friend that has been referred by a customer may also contain a co-advertisement that gives away a free sample of product (e.g. a free 4-ounce bottle of shampoo), or even offers a discount off of the customer's next purchase of the product.

One embodiment of the invention has been currently implemented in the form of an Internet website entitled, “iLuvMyStylist.com”, and some embodiments of the invention will frequently be referred to in the alternative by the name of this website.

### BRIEF DESCRIPTION OF THE DRAWINGS

FIG. 1 shows an overview of some of the computerized devices, web servers, and network connections used to implement the invention.

FIG. 2A shows an introductory page or first page of the invention's iLuvMyStylist.com website, showing how a client or potential client can use the website's search function to look up a stylist or salon of interest in the website's directory.

FIG. 2B shows an alternate version of the introductory page or first page of the iLuvMyStylist.com website, here formatted for a smaller touch-screen display, such as a smart phone device (e.g. iPhone, Android phone).

FIG. 2C shows a simplified introductory page of the invention's iLuvMyStylist.com website, designed to allow stylists and their clients to immediately see which portion of the site is most relevant for their needs.

FIG. 2D shows an overview of the features and benefits of the system from the stylist's perspective, here showing the system's coupon features.

FIG. 2E shows an overview of the features and benefits of the system from the stylist's perspective, here showing how a stylist may generate a customized coupon for a particular client in response to that client's referral.

FIG. 2F shows an overview of the features and benefits of the system from the stylist's perspective, here showing how the stylist may generate a custom online portfolio and link it to a personal QR code (or other visual or RFID type identifier) put into business cards and advertisements to enable rapid client access to the stylist's online portfolio.

FIG. 2G shows an overview of the features and benefits of the system from the stylist's perspective, here showing how the stylist can use the system to both mange their clients and also determine which clients are generating referrals to the stylist.

FIG. 2H shows an overview of the features and benefits of the system from the stylist's perspective, here showing how the system can make use of online social networks such as Facebook to expedite the referral process.

FIG. 2I shows an overview of the features and benefits of the system from the client's perspective, showing how client referrals can be rewarded with discount product and stylist service coupons.

FIG. 2J shows an overview of the features and benefits of the system from the stylist's perspective, again showing how the stylist may enter into the coupon centered client referral process, and explaining how a network of client referrals can build the stylist's practice.

FIG. 3A shows a webpage explaining to the stylist how to build an online portfolio.

FIG. 3B shows a webpage explaining to the stylist how to add photos and videos to their online portfolio.

FIG. 3C shows an example of an individual stylist's completed directory page. For simplicity and ease of use, if desired the directory page of a salon may use the same format. If a client is viewing the page, the “Edit portfolio” link may be absent, since this link is generally only used by the owner of that particular page to create and maintain the page.

FIG. 4 shows an example of the website's edit portfolio page, by which a stylist may upload one or more photo and videos, enter in a brief description of themselves and their services, and produce the directory page previously shown in FIG. 3C.

FIG. 5 shows the webpage where a stylist may further create gift certificates, which are useful for encouraging the word-of-mouth, client-to-friend, referral process.

FIG. 6 shows an example of what a stylists' directory page may now look like after the stylist has created the gift certificate/coupon (previously created by the steps shown in FIG. 5). FIG. 6 also shows how a satisfied client can use the website's “refer a friend” button to dispense a stylist gift certificate to a friend of the client.

FIG. 7A shows an example of how the client may refer the stylist to various client friends either through social networks such as Facebook, or through email.

FIG. 7B shows an example of how a satisfied client can use social networks (such as Facebook) to simultaneously refer and recommend the stylist to one or more of their various online social network friends.

FIG. 7C shows an example of how a stylist referral will show up on that particular friend's social network page.

FIG. 8 shows an example of an alternative email mode of client referrals, showing how a client can use the invention to first enter in the client's name and email, a brief introductory message, and the email of a referred friend into the system. FIG. 8 also shows an example of a confirmation page that can be seen by the client after the email based referral has been sent.

FIG. 9 shows how the friend of the client can receive the email referral message. This email referral can contain a link to the stylist's gift certificate.

FIG. 10 shows how clicking on the gift certificate link from the referral email, previously shown in FIG. 9, can link the friend's web browser to both the stylist's directory page (in the background) and to a $40 off gift certificate (shown in the foreground). The referred friend may then either print out the gift certificate and/or view the stylist's directory page.

FIG. 11 shows an example of a printed-out gift certificate. This example also shows how the same gift certificate can incorporate a co-advertisement or co-branding section. The gift certificate may additionally incorporate a QR code or other type code to make it easy for the client's friend to in turn either refer other friends or visit the stylist's directory web page.

FIG. 12 shows an example of how a QR code incorporated into the stylist's directory page or coupon can be scanned by a smart phone (or other computerized device being used by a client or friend of a client), and this in turn can give the appropriate stylist directory link to the smart phone.

FIG. 13 shows a similar example of how a QR code incorporated into the stylists' business card can in turn link someone else to the stylist's directory page, where again referral gift certificates/coupons may be dispensed.

FIG. 14 discusses the features and benefits of the invention's use of two different QR codes (or other visual or RFID identifiers). Here one QR code (QR code 1) refers to the stylist's portfolio, while the other QR code (QR code 2) refers to that stylist's particular list of clients.

FIG. 15A shows how the stylist can manage their portfolio of clients, as well as a list of corporations where the stylist may have various co-marketing agreements.

FIG. 15B shows the portion of the system that allows the stylist to manage their various co-promotion agreements with other established companies.

### DETAILED DESCRIPTION OF THE INVENTION

It should be understood that although the term stylist and salon will be used throughout this disclosure as an example of a specific embodiment of the invention, the invention itself may be used for other professions as well, for example personal fitness trainers. In general any profession where there is a large personal service component to the work may benefit from this invention. Thus the use and specific examples of stylists and salons in this disclosure are intended as examples only, and are otherwise not intended to be limiting.

One objective behind the invention is to give stylists a consistent online (web based) “home”. At present, a many stylists rent space in salons, and often these renter stylists do not have the time or means to create their own personal websites. Even some salons have the same problem. Thus one aspect of the invention provides stylists with a one-stop internet place where they can show off their portfolio, show photos and videos, show contact information, and provide maps to the stylist's particular workplace. Translation services, for example in the form of a link to an electronic translator or translator website (e.g. Google translate) may also be provided.

Some stylists do have their own individual websites (i.e. websites separate from the web pages provided by the invention). The invention may also allow these stylists to create a link to their individual websites as well.

In some embodiments, there may be different membership levels, such as basic membership and more premium membership levels available for extra fees. Thus certain basic services may be given to a first membership level for little or no cost, while more premium services, such as providing links to individual websites, hosting videos, and the like may be provided as one or more premium levels of membership at higher cost. Alternatively or additionally, manufacturers, distributors and advertisers, who may wish to partner with stylists and salons for various co-marketing activities, may elect to pay for such premium services as an inducement for cooperation.

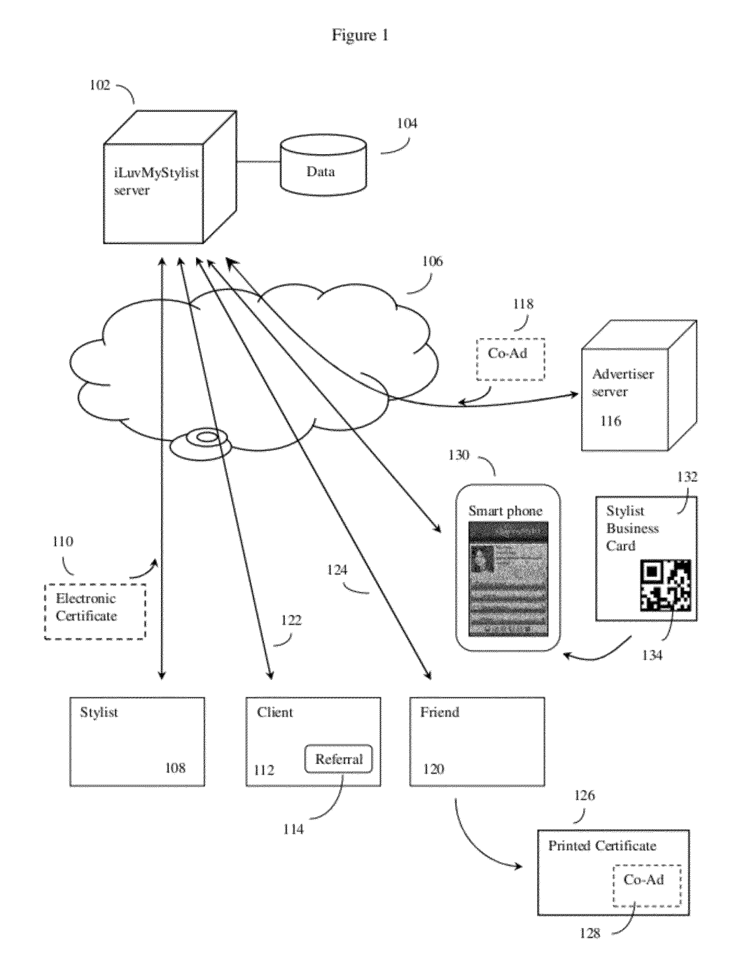

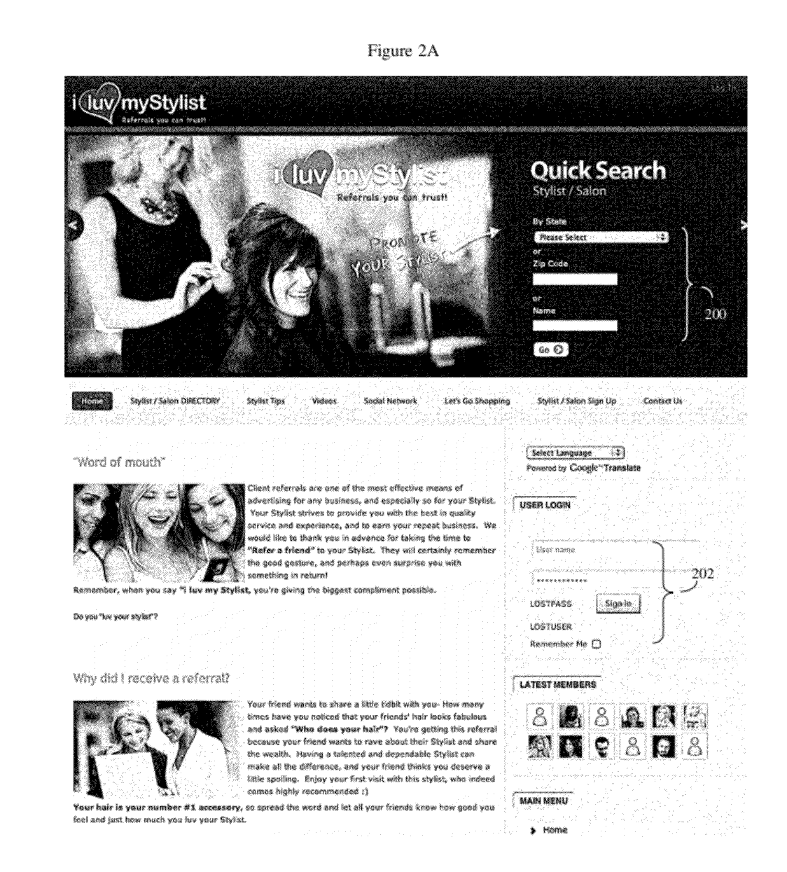

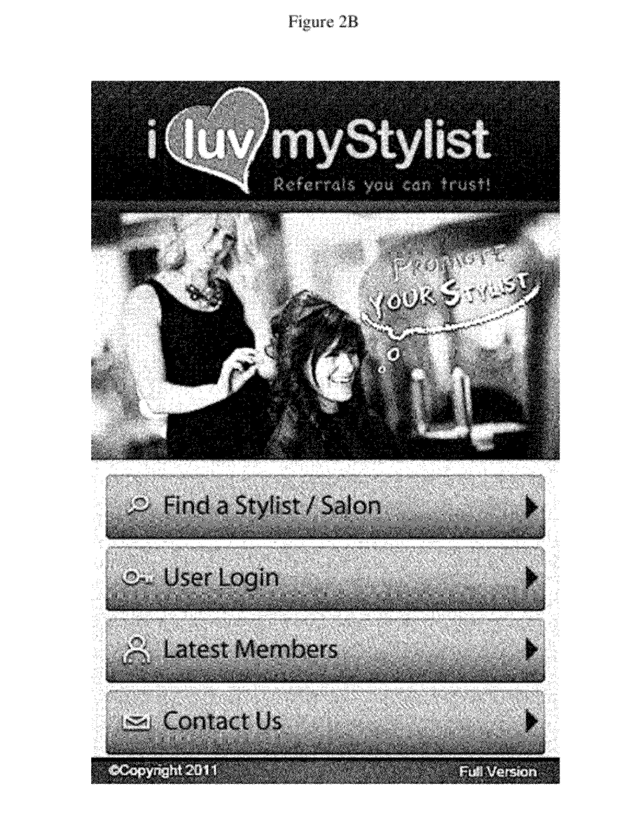

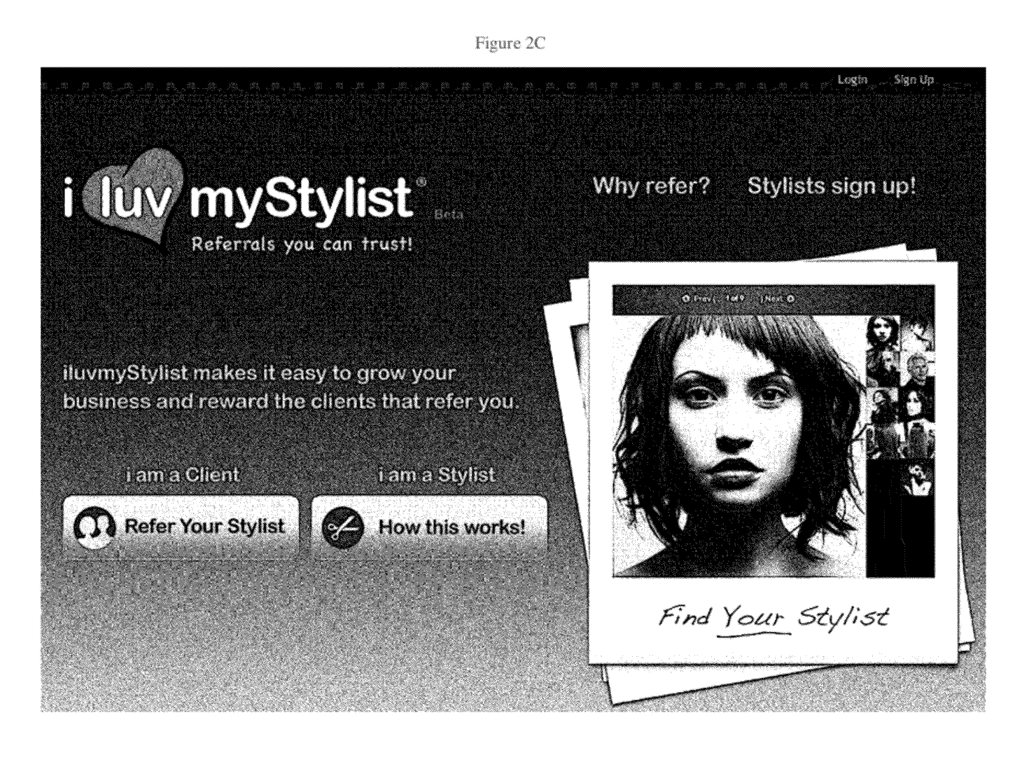

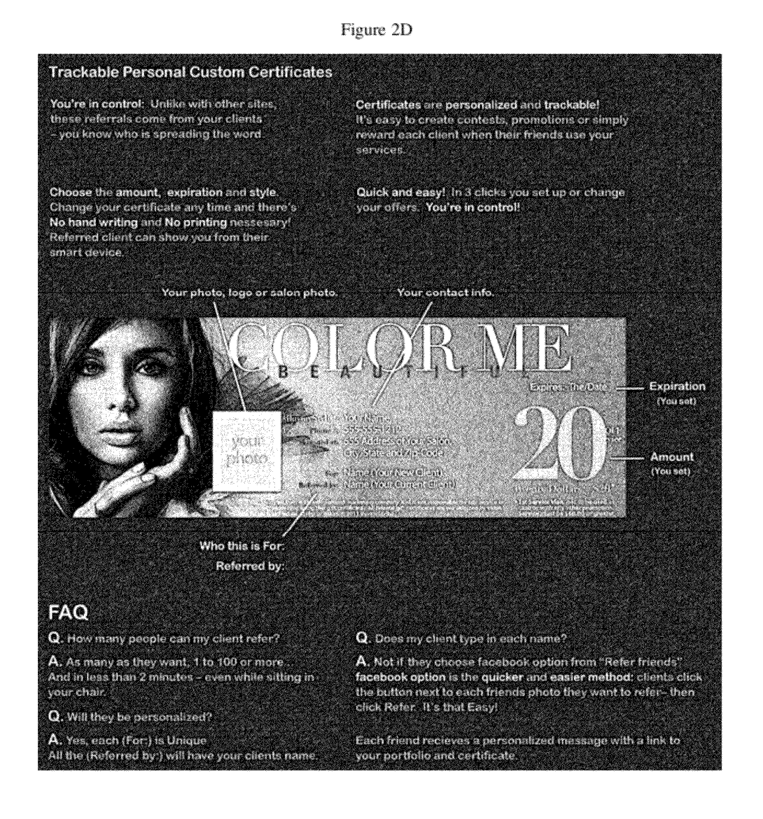

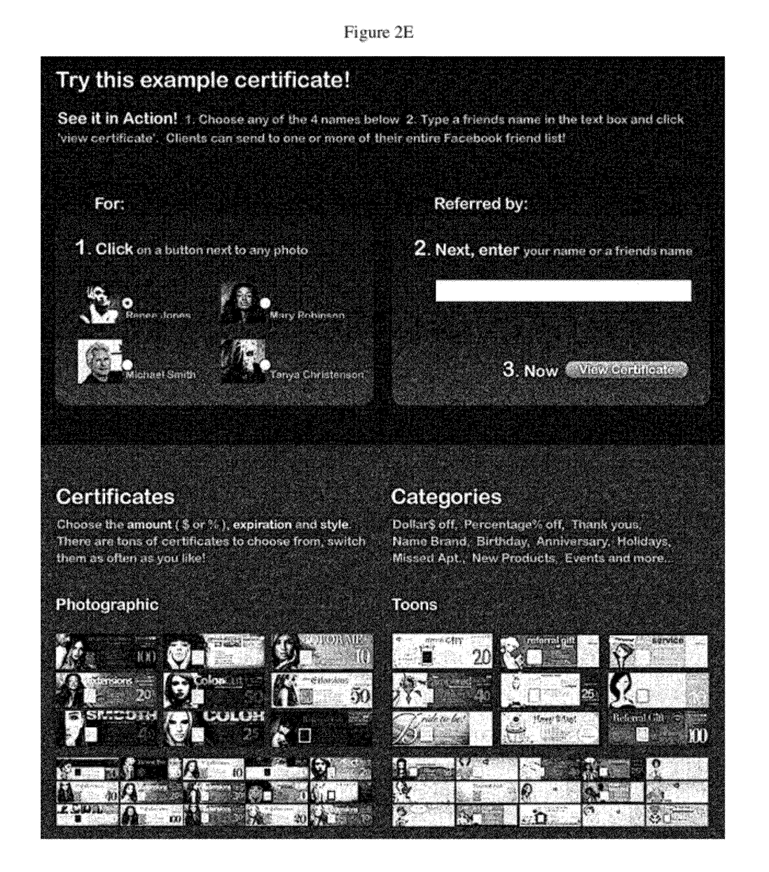

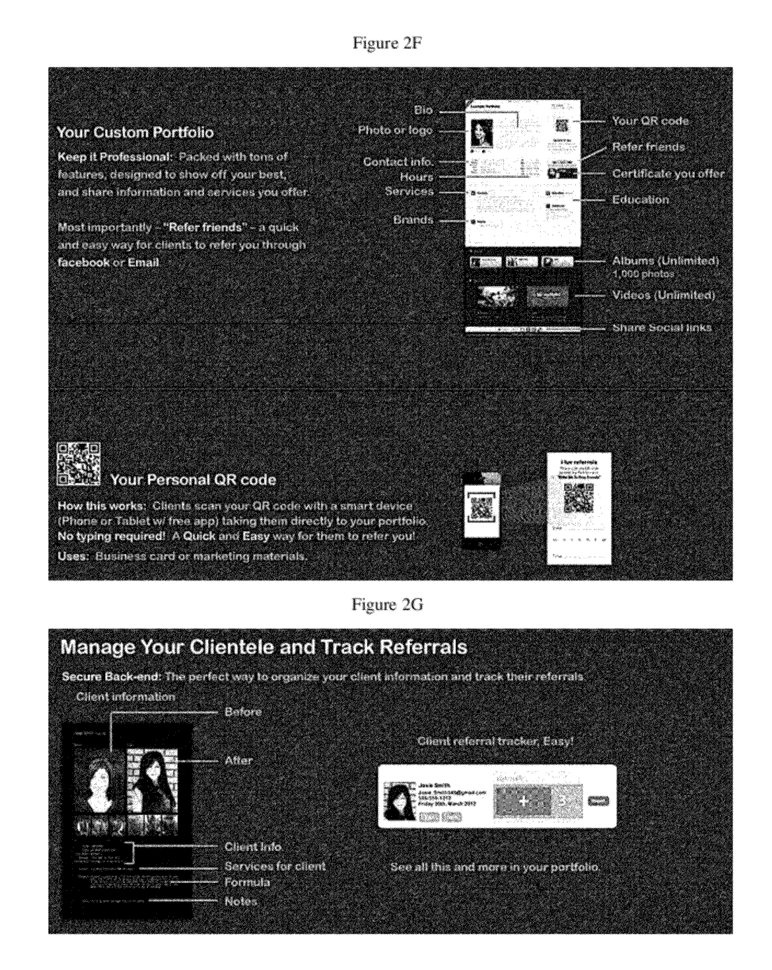

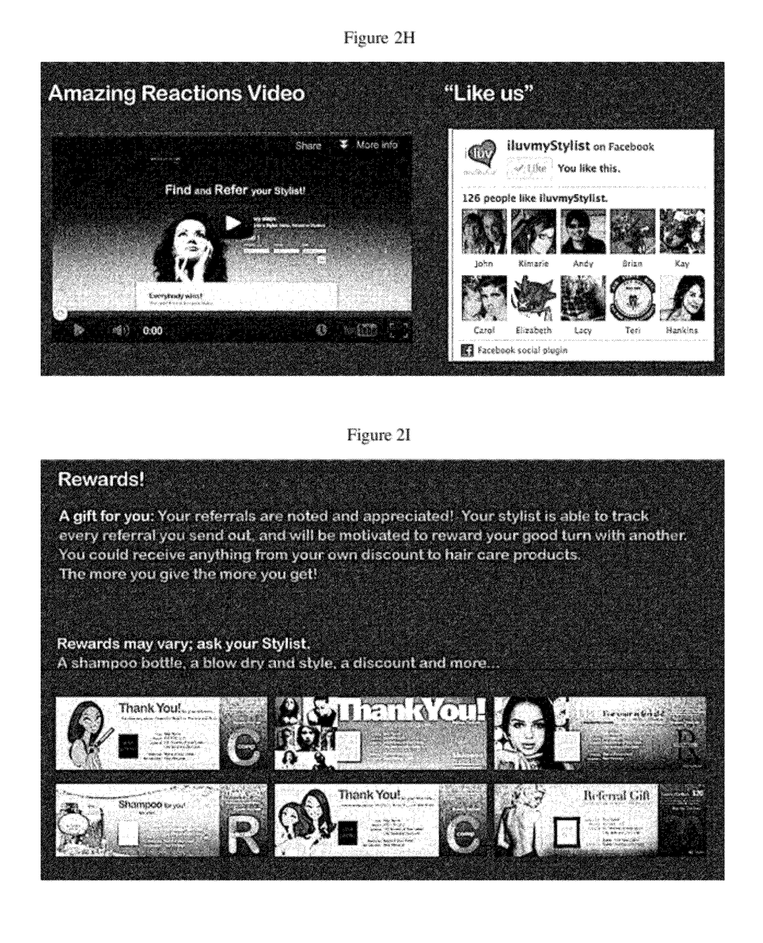

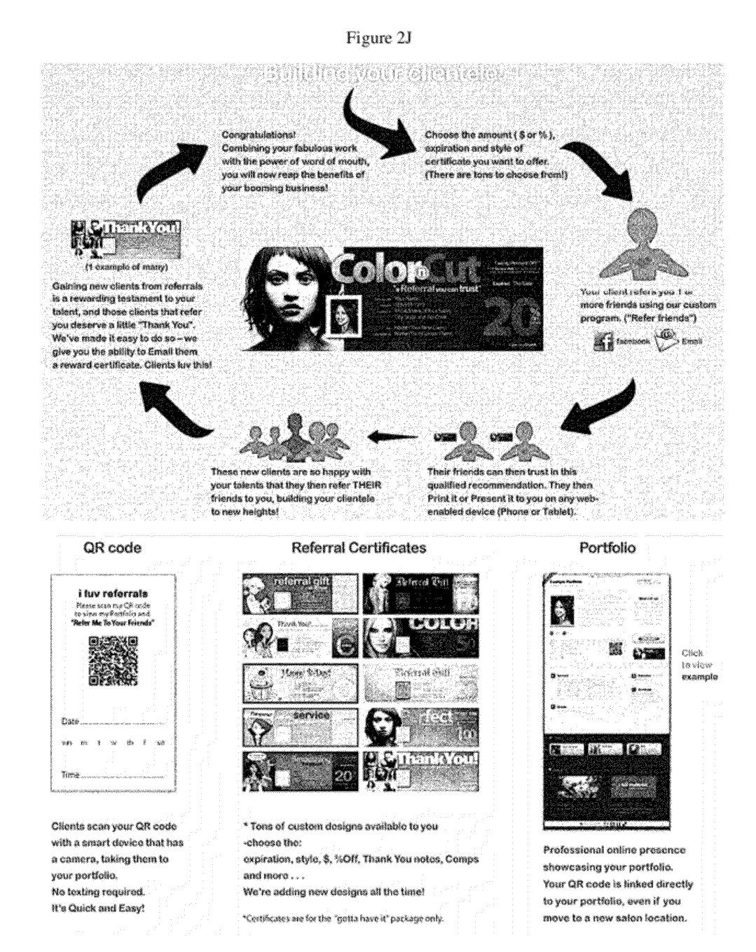

A diagram showing some of the various computerized devices, hardware, and software used to implement the invention's system and method is shown in FIG. 1. Much of the functionality discussed in FIG. 1 will also be discussed in much more detail in FIGS. 2-13, but FIG. 1 can serve as a convenient reference to see how the various aspects of the invention interact in context.

The invention will often be implemented, at least in part, by software running on an Internet web server (102), and various standard Internet connected computerized devices. The web server portion of the invention may be implemented using standard web server operating systems and support software. In the specific iLuvMyStylist.com website example discussed here, the invention was implemented in the form of various PHP software and scripts, running under the Linux operating system, and using an Apache web server or equivalent software. Data, such as stylist and salon portfolio information, gift certificate information, as well as optional interfaces to allow outside and advertisers do co-marketing and co-branding activities may be stored in a database (104) and accessed using suitable database software, such as MySQL or equivalent.

In use, various stylists (108) will access the server (102) and database (104) by way of the Internet (106) network connections using various network connected computerized devices, such as personal computers, tablets (e.g. iPads, iPods), smart phones and the like (108). These devices will typically have at least one computer processor, memory, a display screen, and a graphical user interface that can interact with a touch sensor, keyboard, keypad or mouse device. Often the interaction will be way of various web browsers or dedicated smart phone applications (apps) with web-browser like functionality running on these various computerized devices. The various stylists and salons, here exemplified by computerized device (108) can access the server (102) initially configure their directory information, portfolios, and the like, and also set up various electronic gift certificates/coupons (110) on the server.

Various clients of the stylists can in turn access the server (102) using their computerized devices (112). When the clients access the directory page of the stylist of interest, the clients may additionally refer the stylist to their friends by various means, such as by pushing or clicking on a referral button or link (114) within the client web browser (112).

Additionally, manufacturers and advertisers of products potentially of interest to the customer may, in some embodiments, also access the server (102), often from an advertiser computer, server (116) or other computerized device, and upload co-marketing material such as co-advertising of interest (118) to server (102).

In one embodiment, a present client of the stylist (112) may send a referral to a computerized device owned or operated by the client's friend (120) by clicking on referral button (114), and entering relevant information such as the friend's email address or physical address. This information will be transmitted (122) to server (102), which in turn will transmit an email (124) or other communication (e.g. standard mail) to the friend's computerized device (120). This email may contain a link to the electronic gift certificate or coupon (110). The friend (120) in turn may access or download this gift certificate, and in some cases print out a hard copy of the certificate (126). In some embodiments, this gift certificate will also contain co-advertising material (118), (128).

Alternatively, another friend or client (130) may access the stylists' website from a alternate type of computerized device, such as a camera equipped smart phone or tablet (130), by scanning a stylist business card (or web browser screen) (132) that contains an link to the stylist's directory page in the form of a QR code or other type barcode (134).

FIG. 2A shows an introductory page or first page of the iLuvMyStylist.com website example, hosted by server (102), showing how a client or potential client can use the websites' search function to look up stylist or salon of interest in the website's directory.

Here customers can search for a stylist by state, zip code, stylist or salon partial name or full name (200). Alternatively, clients can directly access a stylist or salon by way of a typed URL or Quick Response code (QR code) Universal Resource Locator (URL) address.

Alternatively a stylist may log in to the website, enter in the appropriate user ID and password (202), and be taken directly to the stylists own directory page. When a registered stylist logs in, the system will often allow the stylist easy access to editing functions in order to easily edit the stylist's portfolio and directory information.

In contrast to FIG. 2A, which shows a full web page such as might be displayed by a conventional web browser (e.g. Internet Explorer, Firefox, Safari, Opera, Chrome and the like) running on a larger sized computerized device display screen, in some cases stylists and clients may prefer to access web server (102) by a smaller form-factor computerized device, such as a smart phone (e.g. an iPhone device, Android device, and the like). In this case, web server (102) may be configured to send a version of the web page configured for a smaller display screen, which also may be a touch-sensitive display screen as well. This is shown in FIG. 2B.

FIG. 2C shows a simplified introductory page of the invention's iLuvMyStylist.com website, designed to allow stylists and their clients to immediately see which portion of the site is most relevant for their needs.

FIG. 2D shows an overview of the features and benefits of the system from the stylist's perspective, here showing the system's coupon features.

FIG. 2E shows an overview of the features and benefits of the system from the stylist's perspective, here showing how a stylist may generate a customized coupon for a particular client in response to that client's referral.

FIG. 2F shows an overview of the features and benefits of the system from the stylist's perspective, here showing how the stylist may generate a custom online portfolio and link it to a personal QR code (or other visual or RFID type identifier) put into business cards and advertisements to enable rapid client access to the stylist's online portfolio.

FIG. 2G shows an overview of the features and benefits of the system from the stylist's perspective, here showing how the stylist can use the system to both mange their clients and also determine which clients are generating referrals to the stylist.

FIG. 2H shows an overview of the features and benefits of the system from the stylist's perspective, here showing how the system can make use of online social networks such as Facebook to expedite the referral process.

FIG. 2I shows an overview of the features and benefits of the system from the client's perspective, showing how client referrals can be rewarded with discount product and stylist service coupons.

FIG. 2J shows an overview of the features and benefits of the system from the stylist's perspective, again showing how the stylist may enter into the coupon centered client referral process, and explaining how a network of client referrals can build the stylist's practice.

Once a particular stylist (or salon) has been identified, either by a search, login, or by a direct URL connection, the directory page on that stylist will be displayed by server (102).

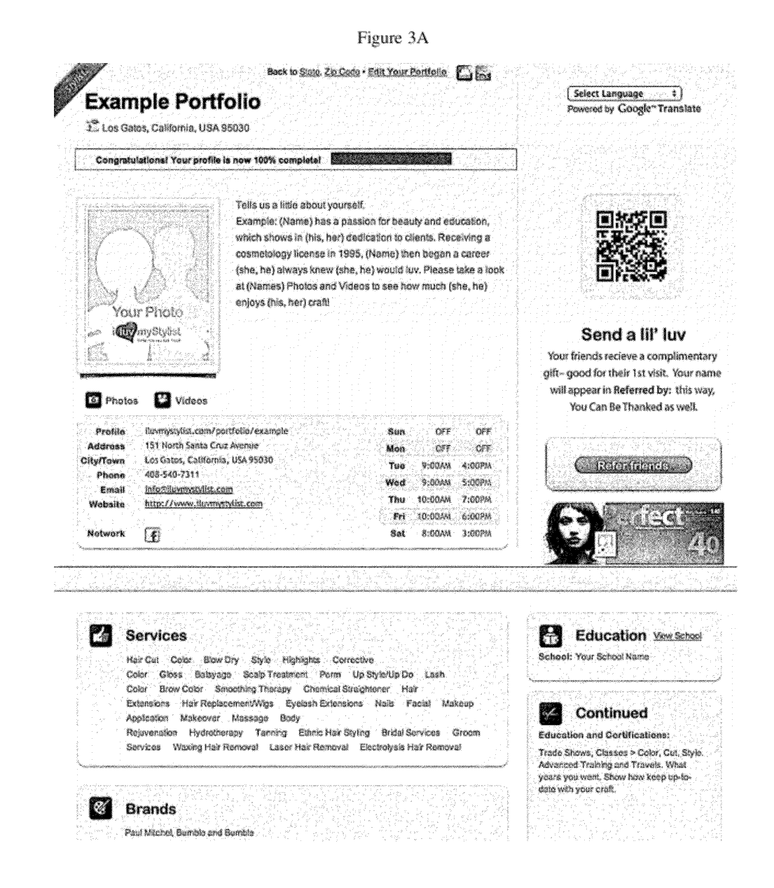

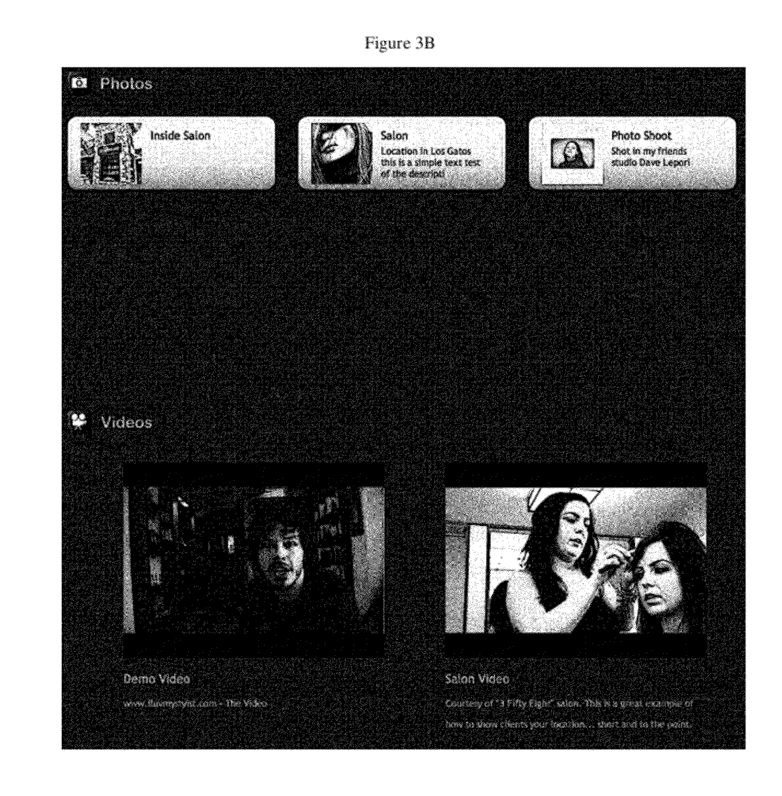

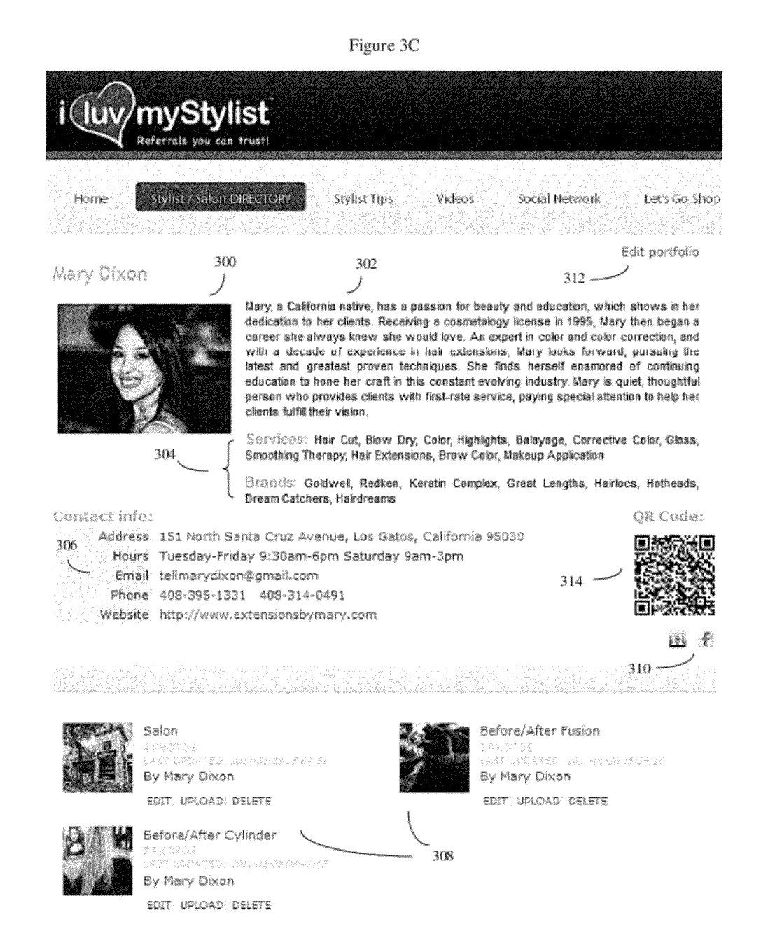

FIG. 3A shows a webpage explaining to the stylist how to build an online portfolio.

FIG. 3B shows a webpage explaining to the stylist how to add photos and videos to the online portfolio.

An example of an individual stylist's directory page is shown in FIG. 3C. The directory page will often show a photo of the stylist (300), give a brief bio and expertise description (302), discuss services and brands of hair care products used (304), and also provide useful contact information (306). Additionally the stylist may add supplemental information, such as photos or videos that might show various procedures in action.

The stylist may also provide links to various social networks, such as Facebook (310), Google+, Yelp, and the like.

In the example shown in FIG. 3C, the stylist has logged in using her id code and password (202), and thus the system has given her directory page editing privileges (312) that are otherwise not available to customers or other outside users.

For simplicity and ease of use, the directory page of a salon may use the same format if desired. If a client is viewing the page, the “Edit portfolio” link (312) will be absent, since this link is generally only used by that particular stylist.

The directory page may also contain a system generated QR code (314) or other visual identifier, barcode, or RFID code that allows outside users to quickly scan the code and access the page. In this example, the QR code (314) simply stores the URL of this particular directory page.

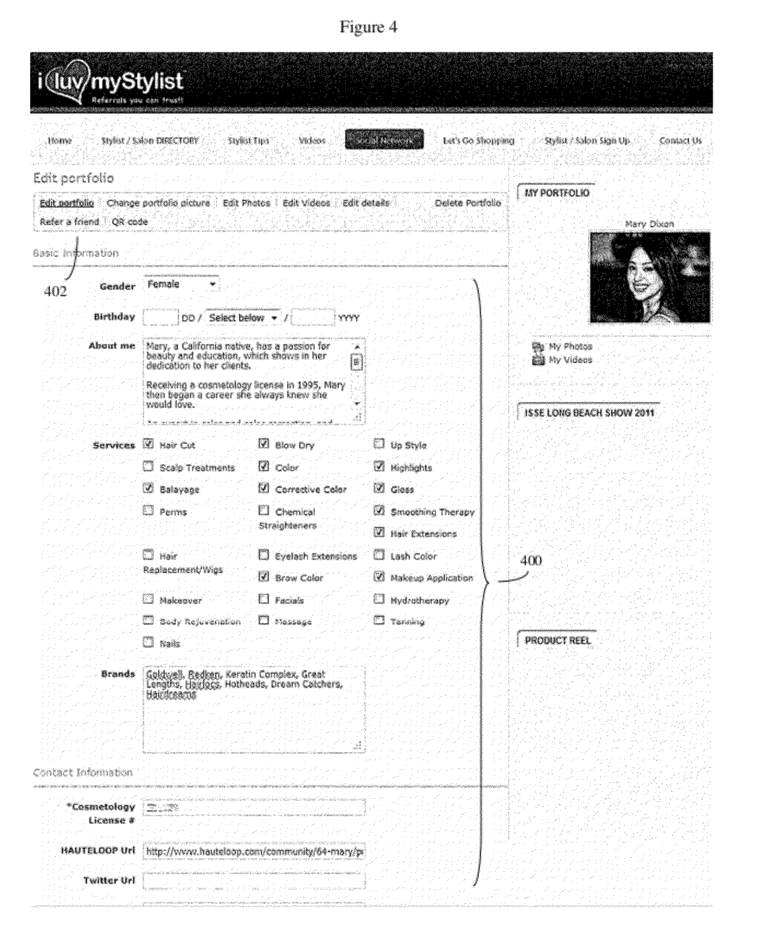

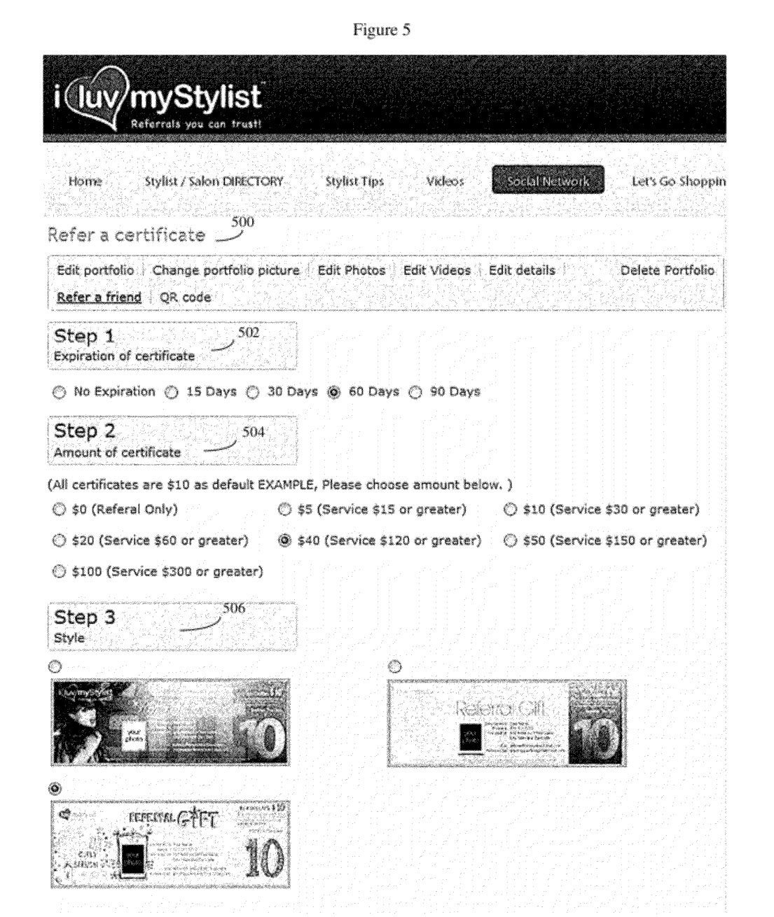

Assume that here the stylist wishes to edit her directory information. To edit this information, she can enter the edit mode by pressing link (312), which will take her to an edit portfolio page, shown in FIG. 4.

The edit portfolio page shown in FIG. 4 allows the stylist to do create or maintain her directory page. The edit portfolio page allows the stylist to change her portfolio picture, edit or upload photos, edit or upload videos, edit her portfolio details, or insert a QR code (as previously discussed, the system will automatically generate the appropriate QR code for the URL address corresponding to the stylist's particular directory page). Some of these user edited directory information fields are shown in (400).

Since stylists often think about gift certificates and coupons in the context of “referring friends”, to simplify the gift certificate creation process, in this embodiment, the gift certificate creation process is accessed through the “Refer a friend” or “Refer a certificate” link (402).

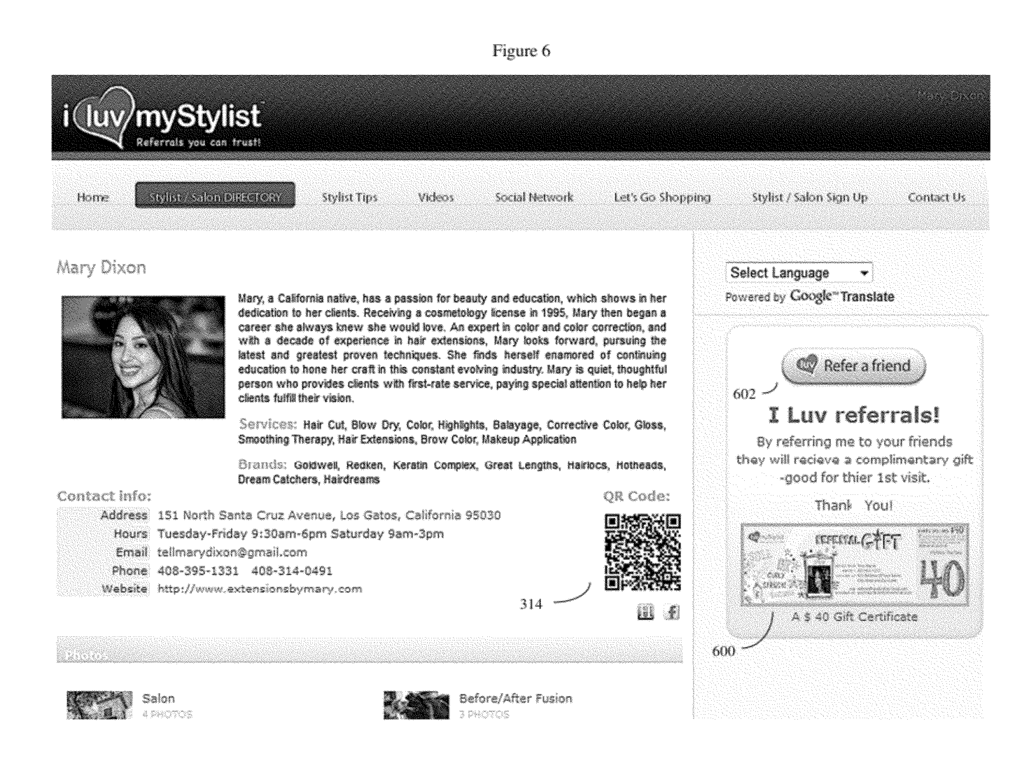

In this embodiment, the process by which a stylist creates a gift certificate/coupon is shown in FIG. 5. FIG. 5 shows the “refer a certificate” webpage (500) where a stylist may create gift certificates, which as previously discussed is useful for the word-of-mouth client-to-friend referral process.

The gift certificate creation process has been designed to be extremely easy to do. Essentially it only requires the user to enter in a few items of information, and then the system will automatically do the rest. Here this information is entered using a three step process.

Step 1 (502), Here the stylist chooses how long the gift certificate/coupon is to last. This is done by setting the printed or electronic expiration date on the certificate, and in this example the stylist is given the options of no expiration (the certificate lasts forever), 15 days, 30 days, 60 days, and 90 days.

Step 2 (504), here the stylist chooses the dollar amount of the gift certificate. It is standard in the industry to give about ⅓ off of the price for services, and to keep the user interface simple, in this embodiment the ⅓ off price is preset by the system. Here the units are $0 (no discount), $5 off of a $15 or greater service, $10 off of a $30 or greater service, $20 off of a $60 or greater service, $40 off of a $120 or greater service, $50 off of a $150 or greater service, or $100 off of a $300 or greater service. In this example, the stylist is choosing to give a $40 off of a $120 or more service gift certificate.

Step 3 (506), the stylist chooses the artistic design or style of the coupon or gift certificate. Here various predesigned templates are provided by the system, and the system will automatically populate these templates with the stylist's photo and contact information, as well as other information (to be discussed). Some of the certificate or coupon template designs or styles may be co-branded styles, where an advertiser, such as larger company, often a manufacturer of beauty products or equipment (116), may partner with the system and stylist to feature shampoos, blow dryers, etc. in the stylist gift certificates (128).

When the stylist wishes to use a co-branded certificate template, the manufacturer or advertiser (116) can implement their co-advertising campaign in various ways, and also pay for the campaign in various ways. The Co-Ad (118), (126) may be a double gift certificate/coupon (e.g. (126), (128)) where a secondary coupon inside of the stylists main gift certificate/coupon gives a price discount or free sample of the manufacturer's product.

As previously discussed, to accommodate this co-branding functionality, in an alternative embodiment, the web site (102) will also have the capability to allow manufacturers (116), with appropriate site and stylist permissions, to modify the coupons (110), (126) to create and manage advertising campaigns. To facilitate this process, and to allow manufacturers and advertisers great flexibility in managing their campaigns, there may be an advertiser interface to the website (102) (not shown). An additional advantage of this approach is that again with proper permissions, much useful information pertaining to stylist and customer usage patterns of the various products may be obtained, and thus the invention may provide much valuable marketing intelligence to manufacturers, advertisers and distributors of various products.

In some embodiments, the stylist may be given controls to allow or disallow such advertisements and promotional activity. Other links and user interfaces, such as service, co branding, giveaways, etc. may also be added to the user interface to manage this function.

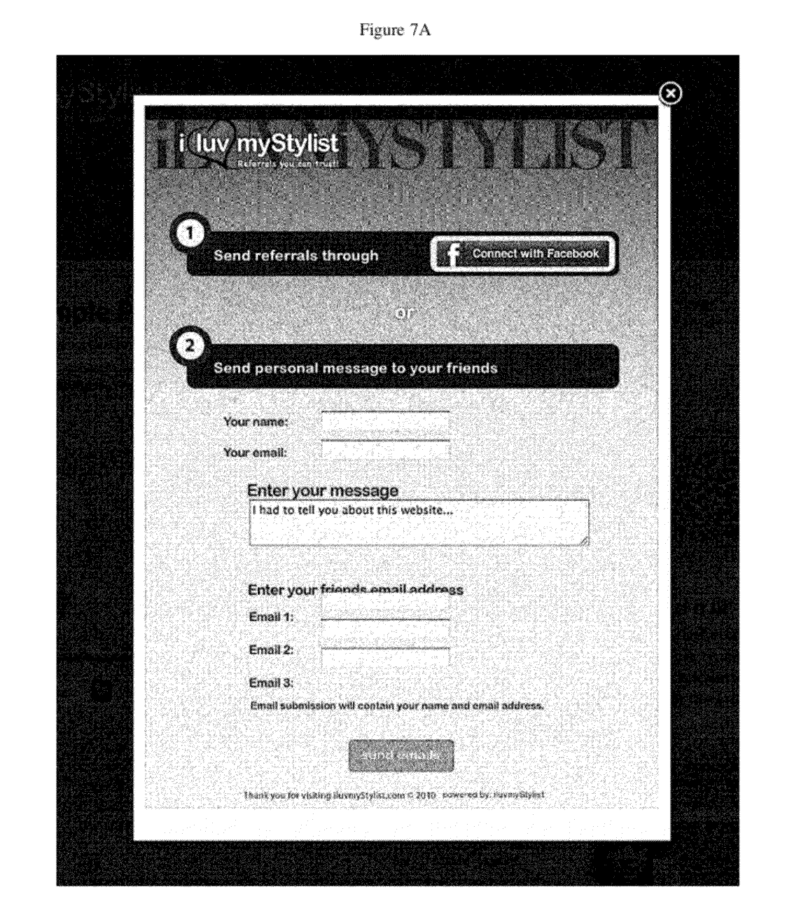

Once the gift certificate/coupon has been created, it now appears in the stylist's main directory page, where it can be viewed by all visitors to the site. This is shown in FIG. 6 (600).

FIG. 6 shows an example of what the stylists' directory page now looks like after the stylist has created the gift certificate/coupon (previously created by the steps shown in FIG. 5). FIG. 6 also shows how a satisfied client can use the website's “refer a friend” button (602) to dispense a stylist gift certificate to a friend of the client.

Put alternatively, a client visiting the stylist's directory web page, who wishes to refer a friend to the stylist, can now easily send the previously prepared coupon/certificate to a friend by clicking on the “refer a friend” button (602).

Alternatively, as previously discussed, the stylist's page can have a QR code (314) containing a URL link allowing a client or a friend of a client to use a smart phone to visit the stylist's directory page directly.

How does an existing client or new customer refer a friend? These referrals may be done through direct email, or through various online social networks. One way to access the referral system can be through the stylist's portfolio page, previously shown on FIG. 6. Here, as previously discussed, an existing client or customer (112) who wishes to refer a friend (120), may begin this process by pressing the referral button (602).

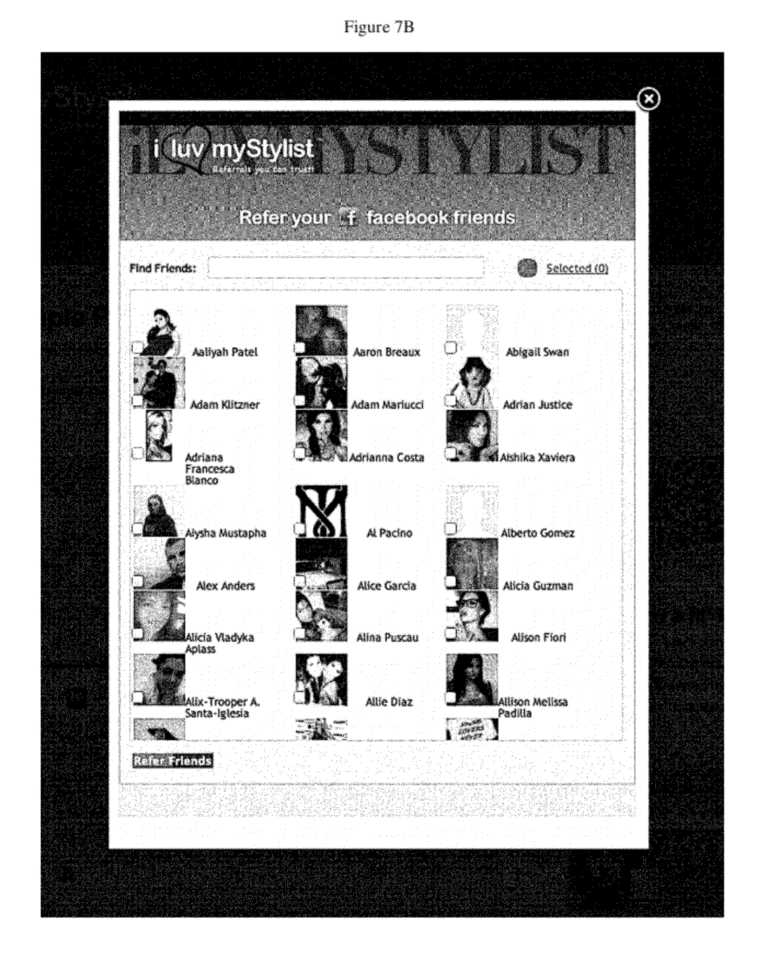

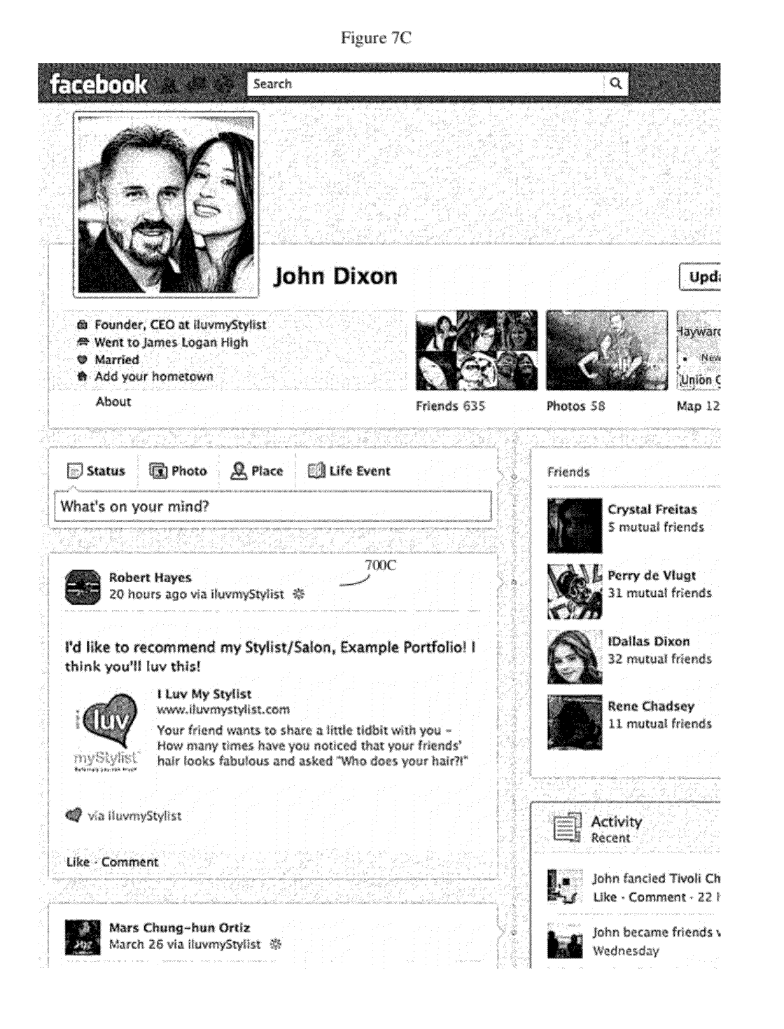

In some embodiments, the system may then give the client various alternative mechanisms designate one or more friends and enter contact information into the system. Here, for example, button (602) may link the client to the referrals page shown on FIG. 7A. This particular referrals webpage allows the client to refer the stylist to a friend through either online social networks (such as Facebook), or through email.

FIG. 7B shows an example of the social network referral system. Here the system can, for example, find the client's various Facebook friends, and allow the client to quickly pick and chose which friends from this friend list might be most interested in the referral.

FIG. 7C shows an example of how a stylist referral (700C) will show up on that particular client's friend's social network page, using this option.

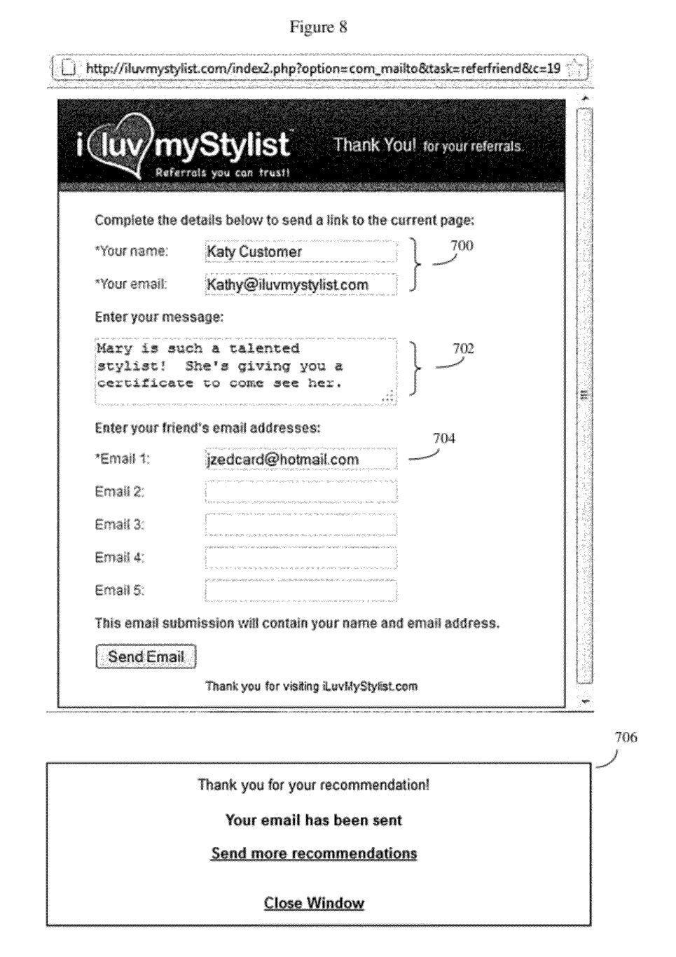

FIG. 8 shows an example the alternative email mode of client referrals, showing how a client can use the invention to first enter in the client's name and email, a brief introductory message, and the email of a referred friend into the system. FIG. 8 also shows an example of a confirmation page that can be seen by the client after the referral has been sent.

In this email option, the system may now presents the client (112) with a new screen or interface where client (112) can type in the client's name and email (700), a brief message (702), and then the email of the friend (120), (704). Multiple recommendations can be made at the same time as desired. Once the customer (112) sends the email (122), the system will then give a confirmation (706) that the email has been sent. The email will then be electronically delivered (124) to the friend's computerized device (120). Additionally, a confirmation email will be sent to the stylist as well. Depending on system settings, a referral log will also be stored in server/database (102)/(104).

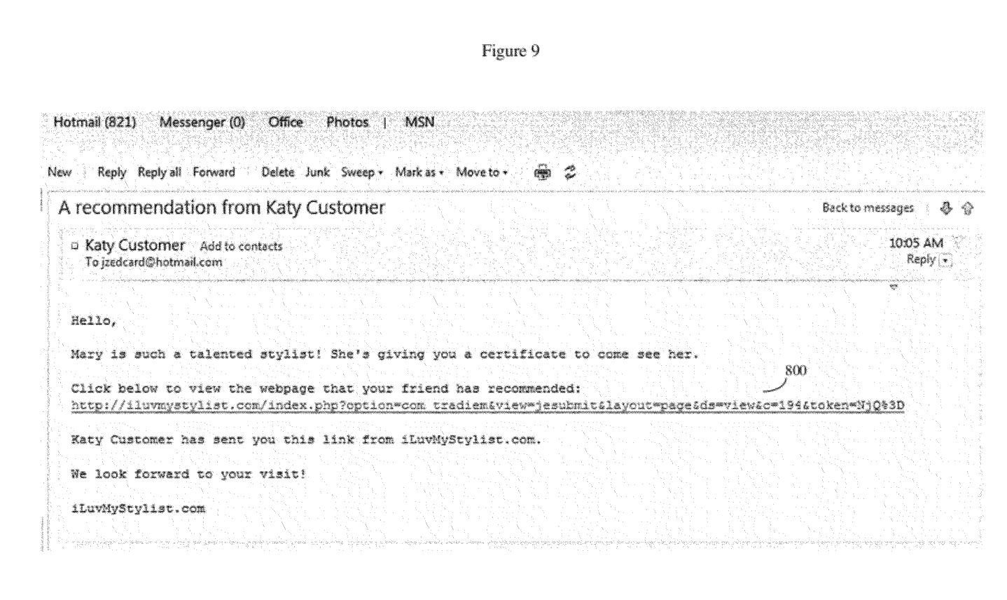

FIG. 9 shows an example of the email that may be received by the friend on the friend's computerized device (120). Here the various fields of the referral from FIG. 8, (e.g. (700), (702), and (704) can be seen, along with a URL link to the gift certificate (800). Alternatively the gift certificate may be embedded in the email as an image.

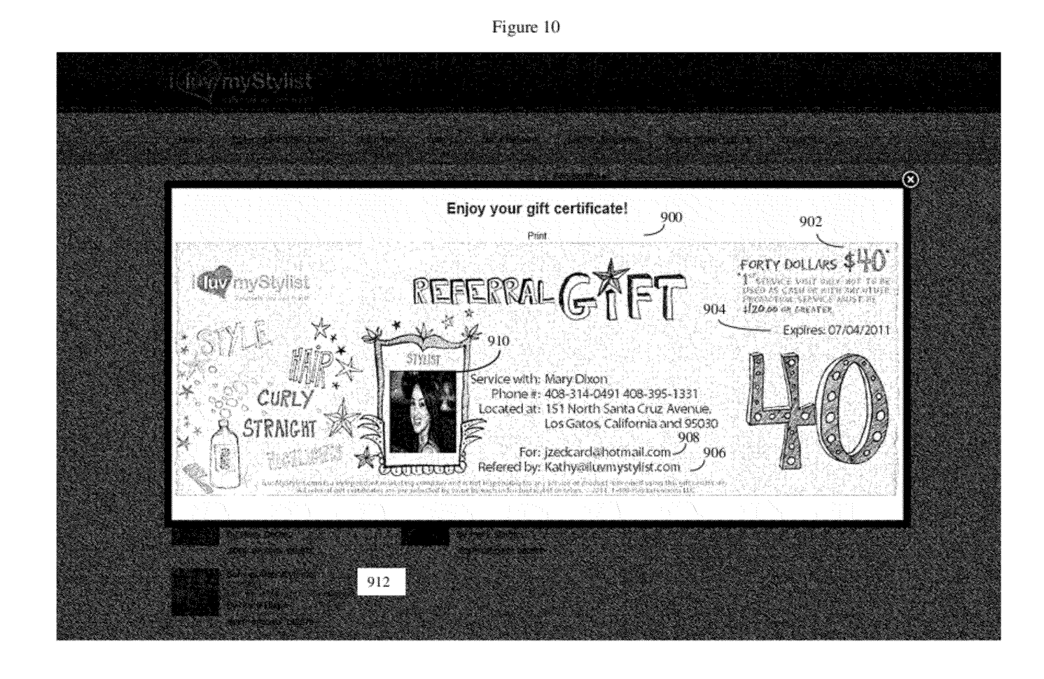

When friend (120) clicks on this link (800), the friend's computerized device (120) can either request the stylists' coupon from server (102), or alternatively display (take the friend to) the stylist's website, where the friend's customized gift certificate/coupon (126) can be found. This is shown in FIG. 10.

As can be seen in FIG. 10, the customized gift certificate/coupon has the coupon style (900), amount (902) and expiration date (904) as was previously designed by the stylist in FIG. 5, as well as the stylist's directory photo (910) or other photo. Additionally the gift certificate is further customized by the customer client name (906) and the friend's email (908) as was previously entered in by the stylist's referring (existing) client in FIG. 8. In this embodiment, the background from the stylist's directory page can also be seen (912). In other words, in this example, gift certificate/coupon (900) is presented as an overlay on the stylist's directory page, previously shown in FIG. 6.

Alternatively, as can be seen in the background in FIG. 10, the friend can at least temporarily close the coupon/certificate window, and instead read about the stylist, by viewing the underlying stylist portfolio page previously shown in FIG. 6. This tells the friend what types of products the stylist uses, how long the stylist has been in business and so on. It also allows the customer to click on the stylists address, which can send the friend to a mapping application such as Google maps, showing where the stylist works. It can also allow the friend to book an appointment with the stylist.

To book an appointment, the system may provide the stylist's calendar, or at least suggest available times for the appointment. To guard against wasting the stylists' time by booking and then later cancellation, the system may also provide a payment mechanism, such as a PayPal or credit card link, where the client or friend may put a deposit down to preserve that appointment.

In some embodiments, the system may also automatically alert the stylist's existing clients as to the stylist's availability, with or without a special discount.

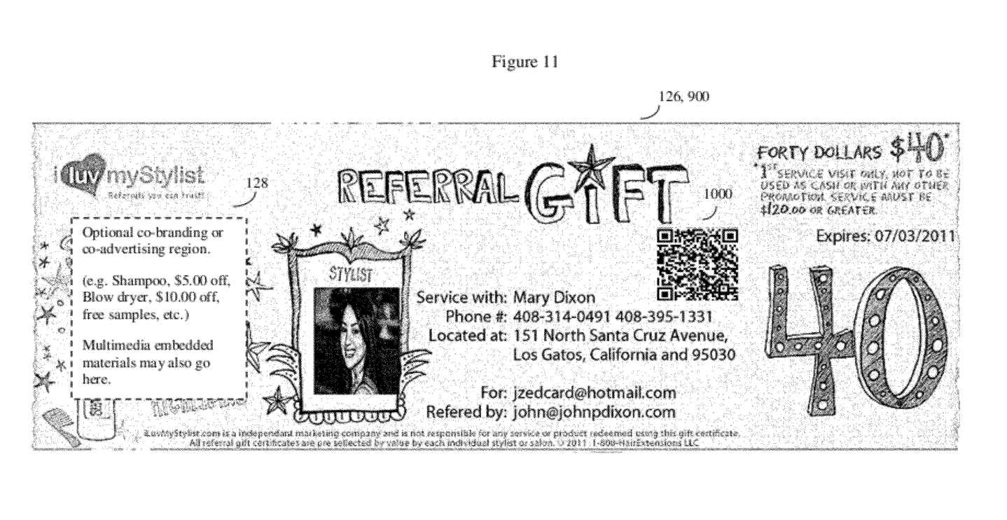

FIG. 11 shows an example of a printed out gift certificate (126). This example also shows how the same gift certificate can incorporate a co-advertisement or co-branding section (128). The gift certificate may additionally incorporate an optional QR code (1000) (or other visual identifier or even an RFID chip) with a URL link to the stylist's directory page to make it easy for the client's friend to in turn refer other friends.

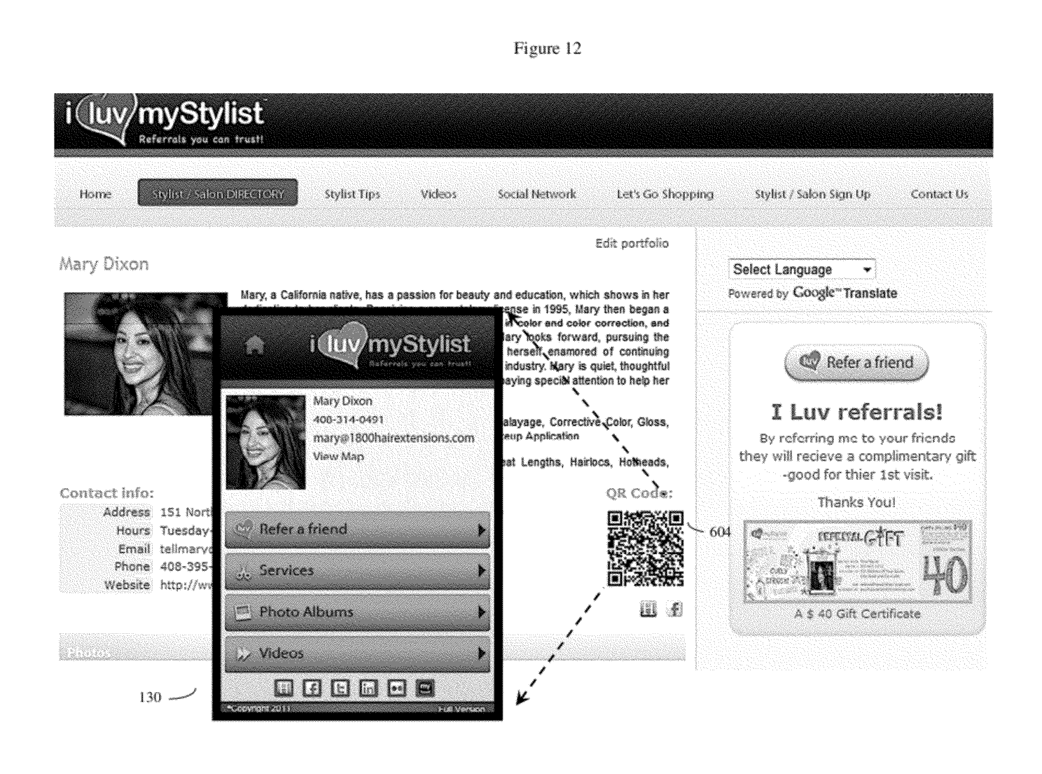

FIG. 12 shows an example of how a QR code incorporated into the stylist's directory page (604) or coupon (1000) can be scanned by a smart phone (130) or other device being used by a client or friend of a client. The QR code in turn can be recognized by a standard QR reader app running on the smart phone, and this in turn can both give the appropriate stylist web page directory link to the smart phone, and the smart phone can then jump to this web page hosted by server (102).

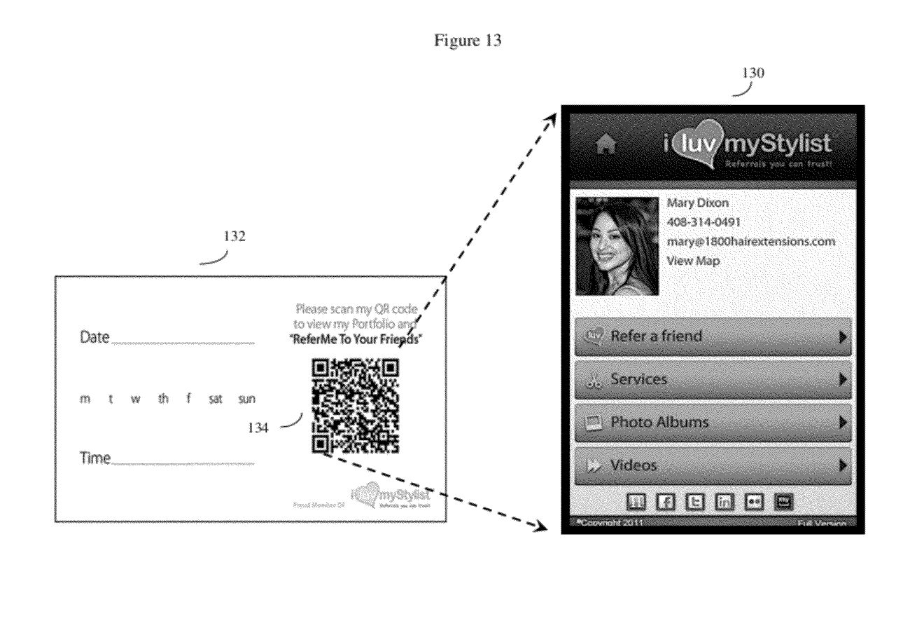

FIG. 13 shows a similar example of how a QR code (134) incorporated into the stylists' business card (132) can in turn be used by the smart phone (130) to link another client friend to the stylist's directory page, where again referral coupons may be dispensed.

The system can also be used to stage friendly competitions. For example, a stylist or salon may wish to stage a competition to see which client can provide the most referrals. To motivate such competitions, these competitions can optionally be tied to either benefits for the clients with the top number of referrals, or benefits to other worthy causes, such as various charities.

Although the printed versions of the gift certificates will, of course, generally be confined to static images, there is no such constraint for electronic gift certificates. In some embodiments of the invention, the gift certificates can also be animated, and may, for example have one or more instances of embedded video, sound, or both. Thus, for example, when a friend or client views the gift certificate on the stylist's web page, as shown in FIG. 9, the image of the stylist (910) could be a video rather than a still image.

Thus an embedded electronic gift certificate/coupon video could show an animated or video greeting in the certificate, and the print certificate can print a static coupon. Cooperative advertisements (128) could also be animated/video advertisements as well, at least when presented on a computerized device display screen.

In an alternative embodiment, the gift certificate/coupon can be used for other functions beyond cash discounts. Examples of such alternative functions include free updos (i.e. a hairstyle for special events), party events, introduction to a new salon or product, contests, models needed (to demonstrate hair products and services), and the like.

In other alternative embodiments, the co-advertisement (128) may be larger than the gift certificate/coupon (126), and the stylist's gift certificate/coupon is thus embedded in the co-advertisement (128). This thus creates the visual impression that the gift certificate/coupon is primarily for the co-advertisement (128), and has been sponsored or endorsed by the stylist.

In some embodiments, the system will provide two different types of QR codes (or other visual identifiers or RFID chip codes) to the stylist. A first type of stylist specific QR code will be a general link to the stylist's portfolio WebPages, as previously discussed, and will generally be open and usable by everyone. A second type of stylist specific QR code is intended to have functions that are more stylist client specific. This second type of QR code, for example, can allow the stylist to use a Smartphone or other device to interact with the stylist's clients—i.e. convey special offers to the client's set up various marketing promotions with the stylist's clients, and so on.

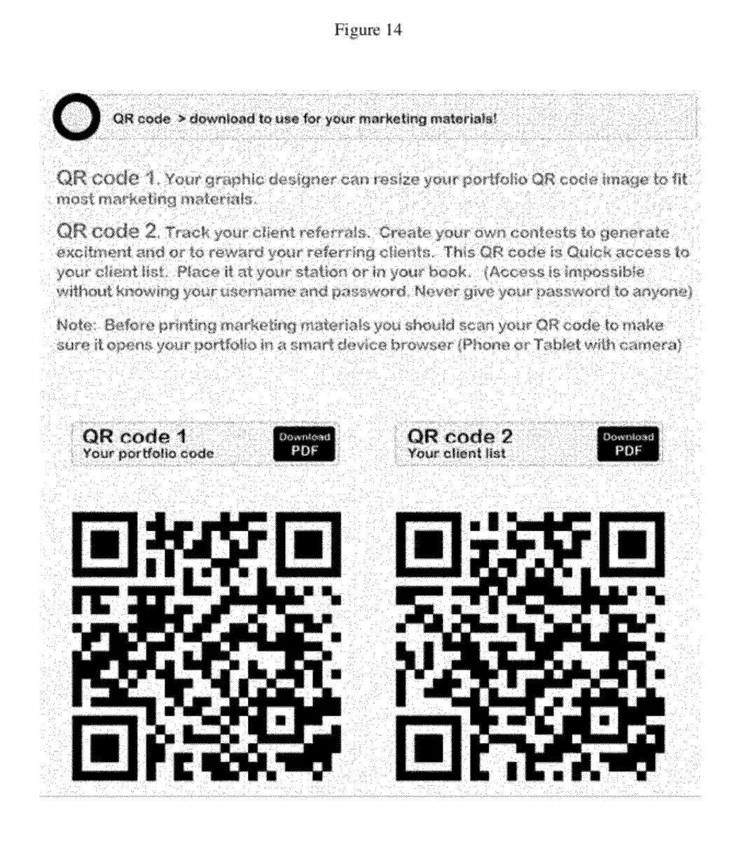

FIG. 14 discusses the features and benefits of the invention's use of two different QR codes (or other visual or RFID identifiers). As previously discussed, one QR code (QR code 1) refers to the stylist's portfolio, while the other QR code (QR code 2) refers to that stylist's particular list of clients.

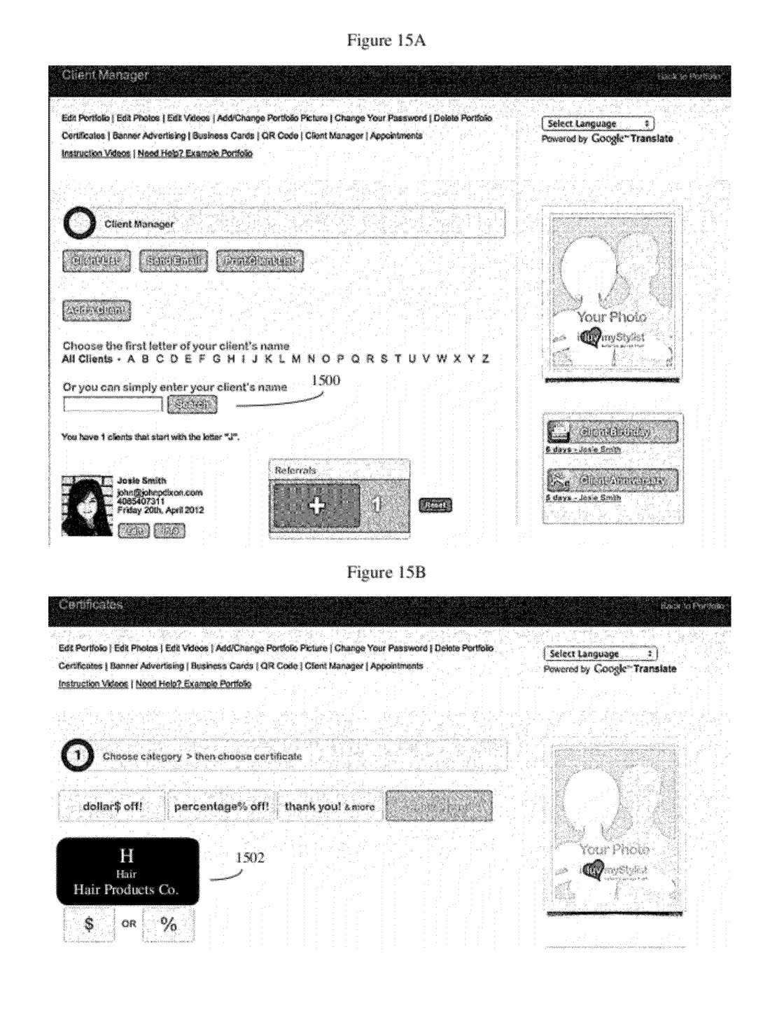

FIG. 15A shows how the stylist can manage their portfolio of clients (1500), as well as a list of corporations where the stylist may have various co-marketing agreements.

FIG. 15B shows the portion of the system that allows the stylist to manage their various co-promotion agreements with other established companies. Here, for example, the stylist has a co-promotional agreement with a leading hair products company, and their (fictitious) logo is shown as (1502).

Other personal services vendors and other services vendors where the present art may be used include artists, restaurants (e.g. retail food vendors), doctors (e.g. plastic surgeons), dentists (e.g. orthodontists), veterinarians, chiropractors, real estate agents and brokers, attorneys, fitness centers, private trainers, florists, photographers, musicians, makeup artists, building construction contractors, sports arenas, and parks (e.g. recreational parks, skate board parks, etc.), vacation spots, resorts and theaters.

Additionally, other fields, such as computer and electronics vendors, groceries and pet food stores, gas stations, automobile dealers, phone stores, banks, money lenders, and the like can also make use of the teaching herein.

1. A computerized method of managing referrals from customers of personal services vendors over the Internet, said method comprising:
providing a searchable and URL accessible directory of personal services vendors on at least one web server, said server providing at least one web page of portfolio data for each hair stylist;
further providing, on said at least one web server, gift certificate dispensing software, said gift certificate dispensing software being configured to accept as inputs, at least some directory information on an individual personal services vendor, a gift certificate duration, gift certificate amount, and gift certificate style, and producing as outputs a link from said individual personal services vendor's at least one web page to an electronic gift certificate dispenser;
referring a customer of said individual personal services vendor to said individual personal services vendor's at least one web page;
wherein when said customer accesses said individual personal services vendor's at least one web page and activates said link, said gift certificate dispensing software will further accept as inputs contact information from said customer and contact information for a customer referral; and
electronically dispense a gift certificate to said customer referral that is customized with at least some directory information on said individual personal services vendor, a gift certificate duration, gift certificate amount, a gift certificate style, contact information from said customer, and contact information for said customer referral.

2. The method of claim 1, wherein said personal services vendors comprises hair stylists and/or hair salons.

3. The method of claim 1, wherein said gift certificates further comprise computer recognizable identification markers capable of allowing a computerized device to automatically extract at least a URL code.

4. The method of claim 3, wherein said computer recognizable identification markers comprise optical identification markers, magnetic markers, or radio frequency identification markers.

5. The method of claim 4, wherein said optical identification markers comprise QR codes.

6. The method of claim 1, further providing software on said at least one web server capable of allowing said personal services vendor to further enter in co-marketing information pertaining to co-marketing agreements with other organizations.

7. The method of claim 6, further using said personal services vendor to select said co-marketing information to further customize said gift certificates to include co-marketing promotional products and/or services.

8. The method of claim 6, further providing software to enable at least one organization participating in co-marketing agreements with said personal services vendor to obtain information pertaining to said personal services vendor's customer referrals.

9. The method of claim 1, wherein the gift certificate dispensing software operates thorough either direct email or thorough online social network information exchange.

10. A computerized method of managing referrals from customers of hair stylists over the Internet, said method comprising:
providing a searchable and URL accessible directory of hair stylists on at least one web server, said server providing at least one web page of portfolio data for each hair stylist;
further providing, on said at least one web server, gift certificate dispensing software, said gift certificate dispensing software being configured to accept as inputs, at least some directory information on an individual hair stylist, a gift certificate duration, gift certificate amount, and gift certificate style, and producing as outputs a link from said individual hair stylists' at least one web page to an electronic gift certificate dispenser;
referring a customer of said individual stylist to said individual stylist's at least one web page;
wherein when said customer accesses said individual stylists' at least one web page and activates said link, said gift certificate dispensing software will further accept as inputs contact information from said customer and contact information for a customer referral; and
electronically dispense a gift certificate to said customer referral that is customized with at least some directory information on said individual stylist, a gift certificate duration, gift certificate amount, a gift certificate style, contact information from said customer, and contact information for said customer referral;
wherein said gift certificates further comprise at least one computer recognizable optical identification markers capable of allowing a computerized device to automatically extract at least a URL code.

11. The method of claim 10, wherein said optical identification markers comprise QR codes.

12. The method of claim 10, wherein said optical identification markers comprise at least one optical identification marker for said stylist, and at least one different optical identification marker for the customers of said stylists.

13. The method of claim 10, further providing software on said at least one web server capable of allowing said personal services vendor to further enter in co-marketing information pertaining to co-marketing agreements with other organizations.

14. The method of claim 13, further using said personal services vendor to select said co-marketing information to further customize said gift certificates to include co-marketing promotional products and/or services.

15. The method of claim 13, further providing software to enable at least one organization participating in co-marketing agreements with said personal services vendor to obtain information pertaining to said personal services vendor's customer referrals.

16. The method of claim 10, wherein the gift certificate dispensing software operates thorough either direct email or thorough online social network information exchange.

17. A computerized method of managing referrals from customers of hair stylists over the Internet, said method comprising:
providing a searchable and URL accessible directory of hair stylists on at least one web server, said server providing at least one web page of portfolio data for each hair stylist;
further providing, on said at least one web server, gift certificate dispensing software, said gift certificate dispensing software being configured to accept as inputs, at least some directory information on an individual hair stylist, a gift certificate duration, gift certificate amount, and gift certificate style, and producing as outputs a link from said individual hair stylists' at least one web page to an electronic gift certificate dispenser;
referring a customer of said individual stylist to said individual stylist's at least one web page;
wherein when said customer accesses said individual stylists' at least one web page and activates said link, said gift certificate dispensing software will further accept as inputs contact information from said customer and contact information for a customer referral; and
electronically dispense a gift certificate to said customer referral that is customized with at least some directory information on said individual stylist, a gift certificate duration, gift certificate amount, a gift certificate style, contact information from said customer, and contact information for said customer referral;
wherein said gift certificates further comprise at least one computer recognizable optical identification markers capable of allowing a computerized device to automatically extract at least a URL code;
further providing software on said at least one web server capable of allowing said personal services vendor to further enter in co-marketing information pertaining to co-marketing agreements with other organizations; and either:
1) further using said personal services vendor to select said co-marketing information to further customize said gift certificates to include co-marketing promotional products and/or services; or
2) further providing software to enable at least one organization participating in co-marketing agreements with said personal services vendor to obtain information pertaining to said personal services vendor's customer referrals.

18. The method of claim 17, wherein said optical identification markers comprise QR codes.

19. The method of claim 17, wherein said optical identification markers comprise at least one optical identification marker for said stylist, and at least one different optical identification marker for the customers of said stylists.

20. The method of claim 17, wherein the gift certificate dispensing software operates thorough either direct email or thorough online social network information exchange.
